(19) United States
(12) Patent Application Publication
(10) Pub. No.: US 2007/0063940 A1
(43) Pub. Date: Mar. 22, 2007

(54) System and method for managing information handling system display panel response time compensation

(76) Inventor: Randall F. Juenger, Belton, TX (US)

Correspondence Address: HAMILTON & TERRILE, LLP, P.O. BOX 203518, AUSTIN, TX, 78720, US

(21) Appl. No.: 11/231,646

(22) Filed: Sep. 21, 2005

(51) Int. Cl. G09G 3/36

(52) U.S. Cl. 345/87

(57) ABSTRACT

LCD panel response time parameters are stored in local memory of the LCD panel, such as EDID ROM, for retrieval by an information handling system to use in adjusting visual information for presentation on the LCD panel. For instance, a response time compensation engine running on firmware in the graphics controller or in the operating system display driver applies the response time parameters to adjust visual information for improved image quality at the LCD panel. The response time parameters are, for instance, an average of response time of liquid crystal material applied to a non-linear approximation.

### BACKGROUND OF THE INVENTION

1. Field of the Invention

The present invention relates in general to the field of information handling system display panels, and more particularly to a system and method for managing information handling system display panel response time compensation.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interact with a number of peripherals to present, communicate, print or otherwise process information. For instance, liquid crystal displays (LCDs) are commonly used in portable information handling systems and have also become popular for presenting information from desktop information handling systems. Due to their relatively small size, LCDs are used as integrated displays in portable information handling systems, which are typically built with a chassis that houses processing components and a hinged lid that houses the display. Similarly, since LCDs have reduced size compared with conventional cathode ray tube (CRT) displays, provide enhanced resolutions, and consume reduced power, desktop users often select LCD external peripherals to display information.

LCDs operate by passing light through pixels of liquid crystals that alter the color of the light. The color generated by the passage of backlight through liquid crystals is set by drive voltage signals provided from graphics processing components to the liquid crystal material. Red, green and blue color shades are created with varying amounts of light passed by red, green and blue liquid crystal material at each pixel and are combined to present a desired color from the pixel. In a recent improvement to the quality of the image presented by a LCD, response time compensation (RTC) techniques apply an over driving of the drive voltage to the liquid crystal material for a set period of time in order to achieve a more rapid transition of the material to a desired black, white or gray level. The overdrive voltage overshoots the voltage value associated with a desired liquid crystal material state to achieve the state more rapidly and then settles at the normal voltage level associated with the desired liquid crystal state. RTC improves image quality by reducing display motion artifacts, such as shadowing or trailing, when fast moving images are displayed, such as a video image from a DVD.

One difficulty with response time compensation is that response time characteristics tend to vary by LCD vendor, LCD process, LCD panel type and manufacturing variations. Thus, the particular characteristics of a display panel integrated into a portable information handling system are sometimes determined, such as by subjective experimentation, and then incorporated into the graphics subsystem to attempt to improve the quality of the image presented by the display panel. The application of response time characteristics by a graphics controller to visual image information alters the output of the graphics controller to the display panel so that image quality is enhanced for particular response parameters. For instance, artifacts, blurry edges and temporal distortions are reduced during display of moving images. However, manufacturers tend to build portable information handling systems with multiple panel suppliers so that the application of response time characteristics is difficult during a manufacture process. Similarly, LCD panels that interface as external peripherals may interact with a variety of types of graphics control subsystems so that particular adjustments to the output of the graphics control subsystem for the display are difficult to achieve.

### SUMMARY OF THE INVENTION

Therefore a need has arisen for a system and method which adjusts information handling system graphics control subsystem output for LCD panels having varying response time characteristics.

In accordance with the present invention, a system and method are provided which substantially reduce the disadvantages and problems associated with previous methods and systems for adjusting graphics input to a LCD panel to compensate for the response time characteristics of the LCD panel. Response time parameters for a LCD panel are stored on the LCD panel for retrieval by an information handling system. The information handling system applies the response time parameters to adjust visual information for presentation at the LCD panel.

More specifically, a response time parameter table stored in EDID ROM of the LCD panel has response time parameters that represent the response time of liquid crystal material of the panel to transition between different states for presentation of different colors. A response time compensation engine retrieves the response time parameters and applies the parameters to adjust visual information for presentation at the LCD panel. For instance, response time parameters represent an average of response times for liquid crystal transitions as predetermined colors, such as white, black and vary shades of gray, that are fit to a non-linear approximation derived curve. The response time compensation engine adjusts visual information based upon the expected response time for pixel transitions, such as with firmware instructions running on the graphics controller or software instructions running in an operating system driver. The response time parameter table sets adjustments for LCD panel response times with portable information handling systems that integrate the panel in the housing or with information handling systems that interact with the panel as an external peripheral device.

The present invention provides a number of important technical advantages. One example of an important technical advantage is that response time parameters for a LCD panel are stored in the LCD panel so that a graphics control subsystem can retrieve and apply the parameters. The automatic application of response time characteristics by a graphics controller ensures optimal LCD panel performance without user interaction. Further, the graphics controller adjusts to changes in the response time characteristics that occur if the LCD panel is changed by reading the response time parameters of the new LCD panel. The user experience is thus enhanced, particularly with the presentation of moving images whose quality can vary substantially with the response time of an LCD panel.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a portable information handling system configured to adjust visual information according to a LCD panel's response time characteristics; and

FIG. 2 depicts a flow diagram of a process for an information handling system to retrieve and apply LCD response time parameters to presents visual information as images at the LCD panel.

### DETAILED DESCRIPTION

Storing an LCD panel's response time parameters on the LCD panel allows an information handling system to retrieve the response time parameters from the LCD panel and apply the parameters to adjust visual information for presentation at the LCD panel. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

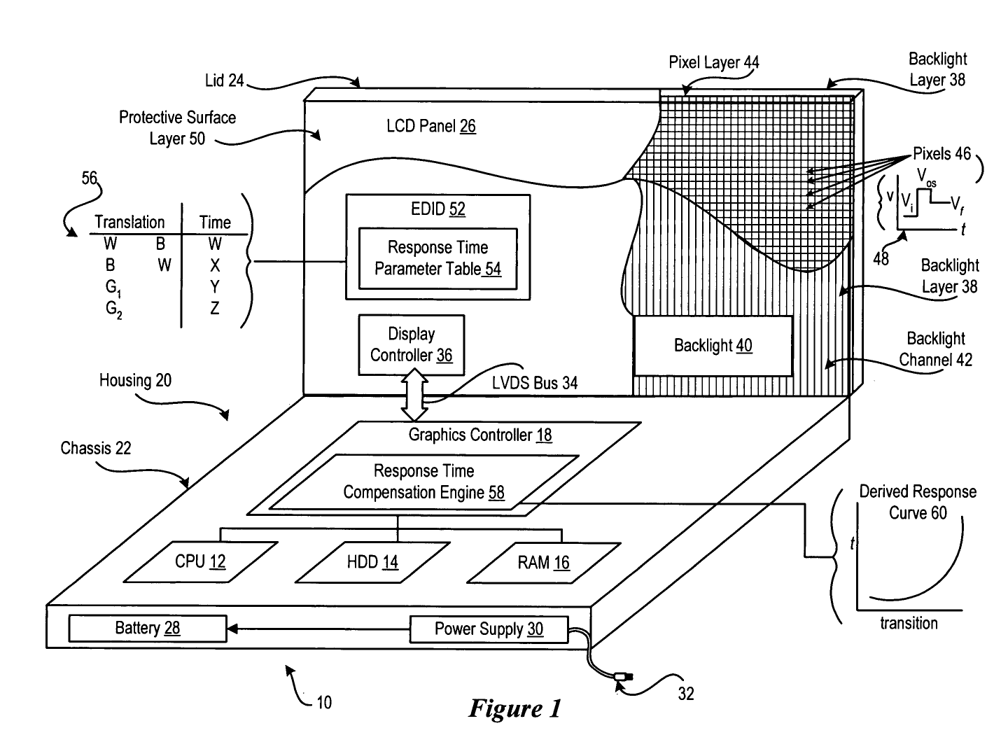

Referring now to FIG. 1, a block diagram depicts a portable information handling system 10 configured to adjust visual information according to a LCD panel's response time characteristics. Portable information handling system 10 is built from plural processing components, such as a CPU 12, hard disk drive 14, random access memory 16 and graphics controller 18. The processing components are disposed in a housing 20 having a chassis 22 with a lid 24 rotationally coupled to rotate between an open position and a closed position. A LCD panel 26 is integrated in the lid 24 to present images from visual information generated by the processing components when the lid is in the open position. Portable information handling system 10 differs from desktop systems in that portable system 10 has components integrated within housing 20 to operate independent of a fixed position. For instance, integrated LCD panel 26 presents images while system 10 is mobile and a battery 28, rechargeable by a power supply 30 and external power 32, provides power to the processing components when external power is unavailable.

LCD panel 26 presents images from visual information sent by graphics controller 18 through a LVDS bus 34 to a display controller 36. LCD panel 26 presents an image with a backlight layer 38 that provides illumination from a backlight 40 through backlight channels 42 to a pixel layer 44 superimposed over backlight layer 38. Pixel layer 44 has plural pixels 46, each pixel having a red, a blue and a green filter, each of the filters having liquid crystal material to selectively alter the amount of light allowed to pass through its associated filter. Display controller 36 presents an image by managing the color provided at each pixel. The color is determined by the amount of backlight that passes through the liquid crystal material into each of the filters. As the color of a pixel changes, display controller 36 provides a drive voltage to each liquid crystal material section to achieve a desired translucence of the liquid crystal material. The response time for the change of the liquid crystal material depends upon the amount of state change and the type of drive voltage applied. For instance, as depicted by chart 48, an overdrive voltage may provide a more rapid response time by transitioning from the initial voltage to an overshoot voltage (or undershoot voltage) before settling at a final voltage. More rapid response times tend to provide improved images, especially with moving images. Pixel layer 44 and backlight layer 38 are held in place and protected with a clear protective surface layer 50.

LCD panel 26 has integrated EDID ROM 52 which stores a response time parameter table 54 having response time values for predetermined liquid crystal transitions that are representative of the response time characteristics of LCD panel 26. For example, table 56 has response times associated with white to black transitions, black to white transitions and plural gray to gray transitions. In alternative embodiments, response time parameter table 54 stores one or more values associated with a non-linear approximation of response times for LCD panel 26 across plural types of transitions. The values reflective of the response time for LCD panel 26 are, for instance, stored during manufacture of the panel based on a determination from the performance of the panel individually or based on a sample lot average performance that selects a closest of plural non-linear approximations of response time. The accuracy of the response time values stored on LCD panel 26 varies in part based upon the amount of storage available in EDID ROM 52, with smaller available storage generally requiring less precise approximations of response time characteristics.

In operation, information handling system 10 retrieves response time parameter table values from table 54 during start-up and applies the response time characteristics to adjust visual information sent for presentation to LCD panel 26. For instance, a response time compensation engine 58 retrieves the parameter table values through LVDS bus 34 and applies the values to derive a response curve 60. As visual information is received at graphics controller 18, response time compensation engine 58 adjusts the visual information to take account of the response time of LCD panel 26. As an example, the color value sent from graphics controller 18 is changed on a pixel-by-pixel basis so that the image presented at LCD panel 26 has improved quality with reduced artifacts, blurry edges and temporal distortion. Although LCD panel 26 of FIG. 1 is integrated into information handling system 10, separate peripheral LCD panels interfaced through an external cable may have visual information adjusted in a similar manner. Response time compensation engine 58 may reside in firmware of graphics controller 18 or, alternatively, may be implemented as a software module, such as a module running within the operating system drive for LCD panel 26.

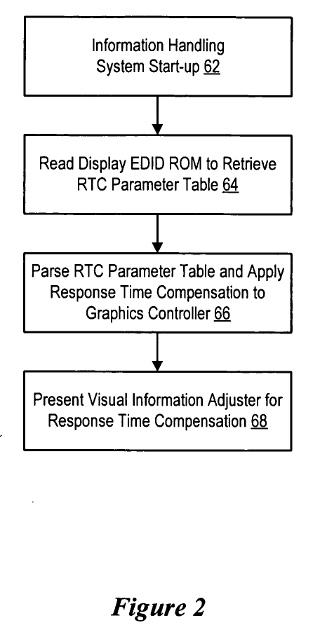

Referring now to FIG. 2, a flow diagram depicts a process for an information handling system to retrieve and apply LCD response time parameters to presents visual information as images at the LCD panel. The process begins at step 62 with the start-up of the information handling system, such as at system boot. At step 64, the LCD panel EDID ROM is read, such as by the video BIOS, to retrieve the response time parameter table values associated with the LCD panel. At step 66, the response time parameter values are parsed and applied so that response time compensation is available adjust visual information generated by processing components of the information handling system for presentation at the LCD panel. At step 68, the visual information generated by the processing components is adjusted to compensate for the response time of the LCD panel pixels to changes in color. The adjusted visual information is communicated to the LCD panel for presentation of images having improved quality relative to the quality that would result from presentation of unadjusted visual information.

Although the present invention has been described in detail, it should be understood that various changes, substitutions and alterations can be made hereto without departing from the spirit and scope of the invention as defined by the appended claims.

What is claimed is:

1. A portable information handling system comprising:
a housing having a rotationally coupled lid operable to move between open and closed positions;
plural processing components disposed in the housing and operable to create visual information for presentation at a display;
a LCD panel integrated in the lid and interfaced with the processing components, the LCD panel operable to present the visual information as images, the LCD panel having response time characteristics associated with the presentation of the images;
a response time parameter table stored in the LCD panel and accessible by the processing components, the response time parameter table having values representative of the LCD panel response time characteristics; and
a response time compensation engine associated with the processing components and operable to apply the response time parameter table values to the visual information to alter the images to adjust for the response time characteristics.

2. The portable information handling system of claim 1 wherein the processing components comprise a graphics controller and the response time compensation engine comprises firmware operable to run on the graphics controller.

3. The portable information handling system of claim 1 wherein the processing components comprise a CPU running an operating system, the operating system having a graphics driver for coordinating communication of graphics information to the LCD panel, and wherein the response time compensation engine comprises a module associated with the graphics driver.

4. The portable information handling system of claim 1 further comprising EDID ROM integrated in the LCD panel, the response time parameter table stored in the EDID ROM.

5. The portable information handling system of claim 1 wherein the response time parameter table values comprise an average of response time values for predetermined liquid crystal transitions.

6. The portable information handling system of claim 5 wherein the average of response time values are applied to a determine a closest of plural non-linear approximations.

7. The portable information handling system of claim 1 wherein the response time parameter table values comprise a value associated with a transition to a black pixel and a value associated with a transition to a white pixel.

8. The portable information handling system of claim 1 wherein the response time parameter table values comprise values determined from plural LCD panel samples.

9. A method for presenting visual information as an image at a LCD panel, the method comprising:
storing response time parameters associated with the LCD panel in permanent memory of the LCD panel;
retrieving the response time parameters from the LCD panel with an information handling system interfaced with the LCD panel;
applying the response time parameters with the information handling system to adjust the visual information based on the response time parameters; and
communicating the adjusted visual information to the LCD panel for presentation as the image.

10. The method of claim 9 wherein the LCD panel is an external peripheral of the information handling system.

11. The method of claim 9 wherein the information handling system comprises a portable information handling system and the LCD is integrated into the housing of the portable information handling system.

12. The method of claim 9 wherein storing response time parameters comprises storing the response time parameters in EDID ROM integrated with the LCD panel.

13. The method of claim 9 wherein applying the response time parameters further comprises applying the response time parameters with a driver of an operating system running on the information handling system to adjust pixel color values for presentation of the image.

14. The method of claim 9 wherein applying the response time parameters further comprises applying the response time parameters with a graphics controller disposed in the information handling system.

15. The method of claim 9 further comprising:
deriving the response time parameters from an average of response time pixel color transitions applied to a non-linear approximation.

16. The method of claim 9 wherein communicating the adjusted visual information further comprises communicating the adjusted visual information through an LVDS bus.

17. A system for adjusting visual information according to LCD panel response time characteristics, the system comprising:
a response time parameter table stored on the LCD panel and having response time parameters of the LCD panel; and
a response time compensation engine operable to run on an information handling system, to retrieve the response time parameter table for the LCD panel, to apply the response time parameters to adjust visual information at the information handling system, and to communicate the adjusted visual information to the LCD panel for presentation.

18. The system of claim 17 wherein the LCD panel comprises a peripheral external to the information handling system.

19. The system of claim 17 wherein the LCD panel comprises a panel integrated into a housing of a portable information handling system.

20. The system of claim 17 wherein the response time compensation engine comprises an operating system driver module.
